(19) United States
(12) Patent Application Publication
(10) Pub. No.: US 2014/0279537 A1
(43) Pub. Date: Sep. 18, 2014

(54) FINANCIAL TRANSACTION SYSTEM AND METHOD CAPABLE OF UTILIZING A MOBILE DEVICE

(71) Applicant: Dean L. Cicoretti, Canfield, OH (US)

(72) Inventor: Dean L. Cicoretti, Canfield, OH (US)

(73) Assignee: EzWay2Pay.Com, LLC., Canfield, OH (US)

(21) Appl. No.: 14/206,624

(22) Filed: Mar. 12, 2014

Related U.S. Application Data
(60) Provisional application No. 61/779,510, filed on Mar. 13, 2013.

(51) Int. Cl. G06Q 20/32; G06Q 20/40

(52) U.S. Cl. CPC G06Q 20/322; G06Q 20/40
USPC 705/44

(57) ABSTRACT

The method and system of this invention employs a mobile application and hardware of a mobile device, such as a smart phone, to recognize a merchant code, such as uniquely identifiable two-dimensional images, to identify a select merchant or vendor. Each merchant code is associated with a particular mechanical device, goods or service available for purchase or payment. Upon recognition of the merchant code, a secure transmission is initiated and created by the consumer/user with a remote server, given that the consumer confirms a secure identity. The remote server also determines credit/funds availability in a transaction account created by the consumer. The transaction account is linked to a funding account. As directed by the consumer/user using the mobile device, a portion or all of the credit/funds are then transferred by the remote server to the vendor/merchant. Upon receipt, the mechanical device or vendor authorizes the delivery of select goods or service to the consumer.

### PRIORITY DATA

The present application depends for priority upon U.S. Provisional Patent Application No. 61/779,510, filed Mar. 13, 2013.

### FIELD OF THE INVENTION

The present invention relates to a cashless payment system, apparatus and method, including corresponding transaction steps initiated by a user/consumer to make possible the payment for identified goods and services through the use of the consumer's mobile device such as a smart phone.

### BACKGROUND OF THE INVENTION

Credit and debit cards have become commonplace within most marketplaces. Carrying cash has associated risks. Many consumers would rather forego transactions involving cash, preferring rather to use alternative methods of payment. With the general societal transition to cashless payment methods (i.e., credit and debit card payments), individuals often find themselves without cash or change to make everyday purchases that often do not typically accept cashless payment methods (e.g., vending machines, parking meters, tolls, donations, payment for services such as taxi charges, etc.). This scenario may leave the consumer in a predicament.

Further, credit and debit card payments often require that consumers take extra time to provide required personal information and a signature on a paper receipt. This can lead to the inadvertent disclosure of personal information that can lead to identity theft. Still further, awkward and hurried fumbling can be rather cumbersome for the consumer in some scenarios, particularly with small purchases, leading to loss of receipts and identity information by carelessness.

Further yet, some vendors/merchants discourage credit and debit card transactions on account of associated merchant costs and fees. More specifically, if a vendor or merchant accepts credit or debit card payments, they generally incur two types of costs when they accept such tender. First, a varying interchange fee is assessed based on the interbank network associated with the cashless payment method. These fees have a substantial range, and the vendor is incapable of determining its associated cost until after the transaction has been completed. Secondly, merchant fees are assessed to the vendor, generally based on a percentage of the total sale. Thus, the precise costs cannot be calculated prior to the point-of-sale. Absent the unpredictable costs to the vendor/merchant, the vendor/merchant may be able to lower its prices with this invention.

Moreover, in view of the foregoing, it is apparent that there is a need for an alternative, more secure cashless financial transaction system and/or an associated apparatus that provides both the consumer and vendor/merchant with the opportunity to pay and receive payment, respectively, for a variety of goods and services with minimal imposition, maximum efficiency, better security, and with reduced cost and fees.

### SUMMARY OF THE INVENTION

This invention includes the concomitant employment of a cashless payment system, method and apparatus, with corresponding technology and transaction account steps that make possible the payment for identified goods and/or services through the use of a mobile device such as a smart phone.

Using this invention, the financial transaction is secure, simple and paperless. More specifically, the transaction account in this case is linked to a secure funding account established by the consumer/user. Then, using a camera, scanner, microphone or keypad of the consumer/user's mobile device, along with a mobile application, a uniquely identifiable merchant code, such as a two-dimensional image, unique call-sounds, or passcode, is recognized to transmit necessary identification information of the vendor/merchant to a remote server. To be clear, the mobile device may implement any input hardware to recognize uniquely identifiable cues, including bar codes, forms of light and/or audio communication signals such as those commonly used for communication between electronic devices. The server associates the uniquely identifiable two-dimensional image, sound or other communication signal to identify the merchant, machine location and/or goods or service being purchased.

In response, the server then leads the consumer/user to a prompt or prompts necessary to continue the transaction. The server also determines credit/funds availability in the user's account. If funds are available, the server (i.e., payer server) provides payment from the customer's transaction account and sends payment to the vendor, merchant and/or service provider's account. To complete the purchase transaction, the vendor/merchant or service provider then authorizes the delivery of the goods or service to the consumer.

If the vendor requires a mechanical action not governed by a teller or an operator, the invention, in this case, includes an apparatus or mechanism in conjunction with the cashless payment mechanism, wherein the server will notify the mechanical device that payment has been transferred from the consumer/user to the vendor/merchant. In certain situations, where, for example, the mechanical device is a vending machine, additional personal communication with the machine may be necessary to complete the transaction (e.g., selection of the vended goods by pushing a button, entering a product item-code for the goods, or pulling a lever). Upon completion of the transaction, an electronic receipt is provided to the consumer's mobile device.

The apparatus or mechanism at the mechanical device, in this case, includes a circuit and its associated ports for the necessary lines by which it may communicate with the otherwise standard mechanical device, such as a standard coffee vending machine. The lines of communication serve various purposes, as necessary, such as communicating that a transaction is in progress, posting the requested credit at the mechanical device once funds have been transferred by the user/consumer to an account of the vendor/merchant, and/or for providing sales information and audit reports for sales made possible using the instant invention. Most importantly, the cashless payment apparatus/mechanism receives information from the remote server when credit/funds are transferred and payment is made to the vendor/merchant's account. Moreover, the apparatus notifies the machine allowing the transaction to be completed.

Therefore, to summarize in most general terms, this invention includes an apparatus and method for payment by a consumer/user using a mobile device. It includes the steps of inputting a merchant code to identify a mechanical device selected by the consumer/user (using the mobile device of the consumer to identify merchant data, including the specific identification of the selected mechanical device), entering a payment amount and confirming a consumer's secured identity data using the mobile device. The mobile device transmits the merchant data, payment amount and consumer identity to a server/payer via the mobile device for: i) verification by the server/payer of available funds in the consumer/user's account; ii) electronic transmission of funds equal to the authorized payment amount to a payee/merchant (who is generally at a location remote from the consumer and mechanical device) for payment to the merchant/payee associated with the merchant data; and iii) the transmittal of authorization data to the identified mechanical device selected by the consumer.

It is important to note that the invention in this case is uniquely advantageous for several reasons. First, the burden of the fees falls to the consumer—not the vendor. The consumer initiates the transaction, rather than the merchant, which typically initiates the transaction process for the allocation of fees. Also, the interchange and merchant fees incurred by the consumer/user are predetermined, and can be accurately assessed and limited at the point-of-sale. Moreover, with this invention the interchange fees will be predetermined based on the terms of the consumer's funding account and can only vary according to the interbank network, which is directly associated with the consumer's account fixed at the time of setup. With respect to the merchant fees, there will only be a set nominal cost, since the consumer/user, rather than the vendor, assumes the liability, burden and responsibility for payment.

Notably, a significant advantage of this invention is that once the transaction account is established, the process does not require any physical tender for payment. The entire transaction may be completed on the consumer/user's side through the mobile application using his/her mobile device. Also, the invention can be implemented in an unlimited number of circumstances and/or equipment since it is incredibly versatile. Further yet, and most important, this invention will encourage a more secure and highly efficient business marketplace and environment.

### BRIEF DESCRIPTION OF THE DRAWINGS

The drawings included herewith are for the purpose of illustration only and not as a definition of the limits of the instant invention, for which reference should be made to the claims appended hereto. Other features, objects and advantages of this invention will become clear from the following more detailed description made with reference to the drawings in which:

FIG. 1 is an overall flow diagram of the financial transaction system according to the preferred embodiment; and

FIG. 2 is a flow diagram that depicts the preferred transactional steps used to make a purchase of goods from a mechanical device, such as a vending machine.

### DESCRIPTION OF THE PREFERRED EMBODIMENT

In basic form, the financial transaction system, in this case, preferably employs a mobile interface application 22 of a service provider 42 and a consumer/user's mobile device 20 with a camera or scanning hardware to recognize uniquely identifiable two-dimensional images (also referred to as a merchant code (MC)). Moreover, each two-dimensional image is associated with a particular vendor/merchant 30 for the sale of one or more goods, select fees, or services available for purchase or payment. The financial transaction system may be used with or without a transaction device or mechanism 16 at a mechanical device 14, such as a vending machine, particularly if the mechanical device 14 is remotely located from the vendor/merchant 30.

Upon recognition of the unique merchant code (MC), a secure session is created with a remote server 40 (i.e., the “payer server”). In the preferred embodiment, the consumer/user 10 must provide a correct secure passcode (SC). The remote server 40 thus communicates a series of prompts to the consumer/user 10. The remote server also determines credit/funds availability in a virtual transaction account (TA) created by the consumer 10. The transaction account is linked to a funding account (FA), and if the virtual transaction account (TA) does not have sufficient credit/funds to complete the transaction, the server 40 must be instructed by the consumer/user 10 to transfer additional credit/funds from the funding account (FA) into the transaction account (TA). If and when sufficient funds are available, the credit/funds are then transferred by the server 40 to the vendor/merchant 30. Upon receipt, the vendor/merchant 30 authorizes the delivery of the goods or service to the consumer/user 10. Preferably, the consumer 10 then receives an electronic receipt (ER) confirming the completion of the purchase or payment.

If the financial transaction system of this invention is being used with a mechanical device 14, such as a vending machine, the uniquely identifiable two-dimensional image indicates this information to the remote server 40. The remote server 40 then additionally notifies the mechanical device 14, via a transaction device 16 located at the mechanical device 14, that a transaction is in progress. The financial transaction system interaction with the consumer/user (described above) is unchanged.

More specifically, following the consumer's completion of the necessary prompts and the authorization of payment transfer to the vendor/merchant 30, the remote server 40 wirelessly notifies the transaction device 16 of the mechanical device 14 that a cashless payment is being made. The transaction device 16, in turn, notifies the currency handling component of the mechanical device 14 via its respective connections and lines of communication. More specifically, the transaction device 16 reports payment to the mechanical device 14, allowing the transaction to be completed. If the transaction requires a personal interaction by the consumer/user 10, he/she may at that point, make the necessary selections or interactions to complete the transaction. For example, if the transaction requires a mechanical action by the machine 14, it is then triggered by the consumer 10. Again, upon conclusion of the transaction, the consumer 10 preferably receives an electronic receipt verifying the purchase and vendor/merchant 30.

It is important to note that the financial transaction system (including server 40) and mechanical device 14 can be used together in a fashion that allows a consumer to make payment or a convenient purchase of goods or service from a machine 14 without the necessity of an operator or teller. Alternatively, the financial transaction system may be used without a mechanical device (e.g., for services) whenever a uniquely identifiable merchant code (MC) is available. The financial transaction system is designed so it may be used in a wide-range of potential business transaction scenarios.

The financial transaction system most generally operates according to a series of method steps by which a consumer uses the camera or scanner hardware of the mobile device 20 in conjunction with a mobile application to initiate the transaction by imaging the uniquely identifiable merchant code (i.e., a two-dimensional image in this case). Through a series of communications between the remote server 40 and the consumer/user 10, through his/her mobile device 20 (via interface application 22), the transaction is completed and credit/funds are transferred from the consumer's virtual transaction account (TA) to the identified vendor/merchant 30. The transaction device 16 of the mechanical device 14 is most generally a circuit capable of communicating wirelessly, preferably encrypted, with the remote server 40 of the service provider 42 and via appropriate communication lines with the device 14 that provides the goods or service. However, this invention may include, in the alternative, wired communication from the vendor/merchant 30 to allow a consumer/user 10 to authorize credit at its mechanical device 14 so that the consumer can complete the purchase using the instant financial transaction system.

Description of Preferred Method Steps and Sequence:

The process steps of the preferred embodiment of the system comprise the following:
An application 22 from the service provider 42 is available for download by the consumer/user 10 to his/her mobile device 20;
A consumer creates a secure code-protected transaction account (TA) either through the mobile application 22 or through any other internet connection via an associated website of the service provider 42;
   The virtual transaction account (TA) is preferably linked to a funding account (FA) of the consumer/user 10, and the consumer may use the mobile application 22 or any other internet connection (via the associated website) to transfer any specified amount of credit/funds to the transaction account (TA) at any time.
   The consumer/user 10 may, alternatively, elect to wait until the point-of-sale to transfer the credit/funds from the funding account (FA) to the transaction account (TA).
   Each transfer of credit/funds from the funding account (FA) to the transaction account (TA) will likely cost the consumer a minimal interchange fee predetermined by the interbank network associated with the funding account (different funding accounts may have varying interchange fees (IF)).
Upon downloading the mobile application 22 and after account activation at the server 40, the consumer/user 10 is then able to open the application 22 to utilize the camera, scanner, microphone and/or keypad hardware contained in the mobile device;
The consumer 10 will then focus the camera, scanner or microphone at the uniquely identifiable merchant code (MC). In the case when the camera or scanner function is used, the merchant code is preferably a two-dimensional image. In the case when the microphone is used, the merchant code is transmitted using sounds detectable by the microphone's receiver. In those situations, the merchant code is alpha-numeric and the keypad of the mobile device can be used. The merchant code (MC) provides and/or identifies the source, vendor/merchant 30, and/or machine identity and location dispensing the goods or providing the service that consumer/user 10 wishes to pay for or purchase;
The application 22 will process and recognize the unique image, sound, or alpha-numeric merchant code (MC), prompting the creation of a secure session with the remote server. Also, the consumer/user 10 preferably provides the remote server 40 his/her secure identification and/or code (SI);
Upon recognition, and provided the secure identification code (SI) is correct, identifying information from the unique merchant code (MC) will be received and accepted by the remote server 40, indicating that a transaction has commenced; and
Based on information associated with the uniquely identifiable merchant code (MC), the server 40 will lead the consumer through a series of prompts. For example:
   If the consumer/user 10 is making a purchase through a mechanical vending machine 14, the application 22 will prompt the user as to how much credit/funds that he/she would like to send to the vending machine 14;
   Alternatively, if the consumer/user 10 is making a purchase of shoes from a printed advertisement, the application 22 may prompt the user as to the color and size he/she wishes to purchase; or
   If the consumer/user 10 is paying a parking meter, toll, or for his/her taxi ride, he/she may be prompted as to the length of time, exit ramp desired, rate charged, total fee, and/or desired gratuity, as the case may be, unless these values are already predetermined at the server 40 using the merchant code (MC). Notably, in the case of this taxi or toll fee for example, this invention can include interaction with the GPS of the mobile device to automatically calculate the total charge at the known rate of the taxi service or toll provider for the calculated distance of the trip.
Subsequently, the server 40 will determine credit/funds availability by employing an online credit processing system (e.g., E4 gateway) for credit/funds approval.
   If credit/funds are already available in the transaction account (TA), the transaction will be processed and the credit/funds will be dispersed from the transaction account (TA) to the vendor/merchant's account (MA).
   If credit/funds are not available in the transaction account (TA), however, credit/funds will be moved from a funding account (FA) (e.g., credit card, debit card, cash or bank account) to the virtual transaction account (TA). A portion or all of the funds in the transaction account (TA) will then, in turn, be transferred to the vendor, thus satisfying the payment amount (PA) requested by the consumer/user 10.
   The transaction will cost the consumer/user 10 a set minimal merchant fee (e.g., $0.12), which preferably is variable.
Depending on the type of transaction being made, the consumer/user 10 may be required to complete the final steps of the transaction outside of the application. For example:
   If the purchase is being made with respect to a mechanical vending machine 14, the consumer/user 10 will then select the item(s) he/she wishes to purchase with his/her allocated credit/funds.
Upon fulfillment of the aforementioned steps, the transaction is completed.
   If the transaction requires a mechanical action or digital input (i.e., identification of a product item-code for selection of goods), the action is then triggered to dispense the good(s) to the customer/user 10. Importantly, the product item-code may be entered using the vending machine 14 keypad or via the keypad of the mobile device 20 using the application 22.
   Upon conclusion of the transaction, the consumer/user 10 receives an electronic receipt from the server 40.

Examples of Use of the Financial Transaction System and/or Method:

There are many potential applications of this invention. For example, the invention may be used for the purchase and payment of goods sold by mechanical devices 14, such as vending machines as discussed throughout. Other examples include, funds credited to a game-of-chance, time purchased and allocated on a parking meter, payment of transportation tolls, and the purchase of products advertised on the internet or by traditional newspaper, magazine or flier advertisements. Still further, this invention can be used to simply pay monthly bills. The foregoing are just a few examples of instances where the system and method described herein could be beneficial. More specifically, the aforementioned examples may be utilized as follows:
Vending Machine Transactions—As previously described using the preferred embodiment, the consumer/user 10 would use the camera or scanner hardware and function in conjunction with the service provider's application 22 on his/her mobile device 20 to recognize a uniquely identifiable two-dimensional merchant code (MC). The two-dimensional image or other merchant code (MC) previously described, would identify and inform the remote server (i.e. payer) 40 as to the initiation of a transaction at a specific machine (generally remote from the vendor/merchant). The server 40 would wirelessly notify the machine or mechanical device 14 via the transaction device 16 as to the initiation of the transaction. The consumer would be prompted by the remote server 40 to input and authorize a desired payment amount (PA) of credit for use at the vending machine 14. The consumer/user 10 would also input a security identification code (SI). If correct, the payer/server 40 would access the consumer's transaction account (TA) and transfer the authorized funds to the vendor/merchant 30. The vending machine 14 would then be notified that the requested funds have been transferred to the merchant's account (MA) to allow for the consumer purchase at the machine 14. The consumer/user 10 would select his vending machine preference through personal or digital interaction with the machine in normal fashion or via the mobile device 20 using the server's application 22. The item(s) would be dispensed by the machine 14 and, if funds remained unused, the consumer/user 10 would either be given a refund through the change dispenser of the machine 14 or credit would be returned to his transaction account (TA). To conclude the transaction, an electronic receipt would be provided to the consumer's mobile device 20 to confirm the transaction.
Games-of-Chance Transactions—The consumer/user 10 would engage a game-of-chance 14, such as a slot machine, using similar interaction with the mobile device 20 as previously described for a vending machine. The remote server 40 would also engage the consumer/user 10 in a similar interaction for cashless payment at such machines. The difference between the two interactions being that the consumer/user would simply play the game-of-chance with his purchased credit rather than select an item for purchase.
Parking Meter Transactions for Time Allotment—In this case, the consumer/user 10 would engage a parking meter 14 in a similar interaction with the mobile device 20 as described above. More specifically, the remote server (i.e., payer) 40 would communicate in an interaction with both the consumer/user 10 and meter 14 similar to that discussed. The consumer/user 10 would purchase time on the meter by authorizing a payment amount (PA). To be clear, in this embodiment, the consumer/user 10 would not have direct interaction with the parking meter. The server would simply transfer the funds to the parking meter vendor/merchant 30, and the time (based on the allocated rate) would be reflected on the meter in accordance with the payment amount (PA).
Transportation Toll Transactions—Similar to the other examples, payment of transportation tolls could utilize this invention in a like fashion. Using the consumer/user's mobile device 20, the consumer would engage in an interaction. The mobile device 20 would be used to signal the server/payer 40, which would in turn signal the toll's mechanical device 14 for payment of a toll. In exchange, the associated gate, for example, would lift upon completion of the transaction.
Purchase of Products Available over the Internet—Using the preferred embodiment, the consumer/user 10 would use the camera or scanner hardware, functions and mobile application 22 on his/her mobile device 20 to begin the process for the purchase of a product over the internet. Upon recognition of the uniquely identifiable merchant code (MC) (i.e., two-dimensional image) displayed on a website, the server 40 would know the merchant and product information. The server 40 would then prompt the consumer/user 10 for his/her security information (SI) as described, and upon successful confirmation of the same, the server/payer 40 would transfer the funds to the merchant's account (MA). Preferably, the potential options and selections will have already been made through the website. The vendor/merchant 30 will simply dispense the selected goods or service accordingly. To confirm the transaction, the consumer/user 10 will receive an electronic receipt.
Products Purchased using Printed Advertisements—If the consumer/user 10 receives a static or printed advertisement, such as a mailed flyer, he/she can use his mobile device 20 in a similar manner as described above to initiate a transaction. More specifically, the consumer/user 10 would input the two-dimensional code by scan, camera or keypad. The payer server 40 is notified, and then it prompts the consumer as to potential options, such as size or color. The payer server 40 requests security information (SI) from the consumer before transferring funds to the merchant account (MA). The vendor/merchant 30 then dispenses the goods or service accordingly. An electronic receipt then completes.

Description of the Transaction Mechanism of the Mechanical Device:

The transaction mechanism 16 used to implement the preferred process steps of the mechanical device 14, optimally includes the following components:
A transaction circuit board with blue-tooth receiver preferably enclosed in an encasement;
Wiring and electrical contacts utilized as connections and data paths for the purpose of communicating with the control microprocessor of the vendor's mechanical device 14 (i.e., vending machine, parking meter, etc.) and the circuit of the currency handling component;
The encasement can include ports for various connection types depending on the employed purpose of the apparatus (i.e., dispensing, vending, allocation of time, crediting the currency handling component with allocated funds, etc.). For example:
   If the mechanical device 14 is a coffee vending machine, the encasement is preferably equipped with multi-drop bus (MDB), including a six-pin connector and data path, and DEX line. The vending machine controller (VMC) should constantly poll the transaction mechanism 16 of the machine 14 to determine whether a transaction is being initiated. The multi-drop bus (MDB) manages the environment and communicates to the vending machine controller (VMC) that a transaction is occurring. Further, the DEX line would be used to provide audit and other transaction reports to the vendor/merchant 30 to show sales information; and
A two-dimensional uniquely identifiable merchant code (MC), including an image (e.g., bar code or QR code), speaker to transmit unique sound combinations for communication with the microphone of the customer/user's mobile device 20, or an alpha-numeric code placed on the encasement of the circuit or at some other location clearly visible by the customer 10 for entry via the keypad of the mobile device 10.

Implementing the aforementioned technology and components, the consumer/user 10 is able to use the mobile application 22 in conjunction with the input hardware on his/her mobile device 20 to identify the uniquely identifiable merchant code (MC) in a transaction. It is important to note that the merchant code (MC) will be slightly different for each mechanical device 14, so that, not only is the vendor/merchant 30 identified, but also the device's location, type, style, dispensed goods, etc. are identifiable by the payer/server 40.

With this design, subsequent to the interaction between the mobile device 20 and the remote server 40, the remote server sends a signal that notifies the transaction mechanism 16, (in turn the associated mechanical device 14) that credit/funds have transferred from the virtual transaction account (TA) of the consumer/user to the merchant account (MA) of the vendor/merchant. As a result, funds are allocated via the currency handling component of the mechanical device 14, so that the consumer/user 10 can make a selection and the transaction is complete as described.

In accordance with the provisions of the patent statutes, therefore, this invention has been explained and illustrated in various preferred embodiments. It must be understood, however, that this invention may be practiced otherwise than as specifically illustrated without departing from the scope of the claims that follow.

1. A method of using a remote computer transaction system for a consumer to conduct a cashless transaction with a vending device having an electronic control interface, the method comprising the steps of:
a) inputting a customer ID code to said remote computer transaction system by said consumer to access said remote computer transaction system;
b) confirming said customer ID, and permitting access to said remote computer transaction system;
c) inputting into said remote computer transaction system a vendor/product code of a selected product to be purchased from said vending device by said consumer;
d) verifying availability from said consumer of funds appropriate for payment of said selected product;
e) sending an authorization signal from said remote computer transaction system to said electronic control interface of said vending device to dispense said selected product; and,
f) making a record of said cashless transaction for said selected product, and providing said record to said consumer.

2. The method of claim 1, wherein step (c) of inputting said vendor/product code initiates a secure connection between said consumer and said remote computer transaction system.

3. The method of claim 2, wherein said authorization signal includes data designating an amount to be credited to said consumer at said vending device.

4. The method of claim 3, wherein step (d) of verifying availability of funds is performed by accessing a transaction account established in said remote computer transaction system by said consumer.

5. The method of claim 1, wherein said consumer accesses said remote computer transaction system using a mobile device.

6. The method of claim 5, wherein said vendor/product code is represented by a two-dimensional image.

7. The method of claim 6, wherein said consumer scans said two-dimensional image to input said vendor/product code into said remote computer transaction system.

8. The method of claim 1, wherein said remote computer transaction system communicates with said electronic control interface of said vending device using encrypted signals.

9. The method of claim 1, wherein said vending device is a food dispensing machine.

10. The method of claim 1, wherein said vending device is a parking meter.

11. The method of claim 1, wherein said vending device is a toll gate.

12. The method of claim 1, wherein the remote computer transaction system allocates a fund level to said electronic control interface, and excess funds are returned to said remote computer transaction system once said consumer has finished using said vending device.

13. A method for a consumer to make a cashless payment using a remote computer transaction system, the method comprising the steps of:
a) distributing a plurality of vendor/product codes to at least one vender wherein said vendor/product codes are stored and correlated in said remote computer transaction system;
b) said consumer communicating with said remote computer transaction system to provide a customer ID code in order to gain access to said remote computer transaction system;
c) said consumer selecting a product to be purchased from a selected vendor, and entering a vendor/product code corresponding to said selected product into said remote computer transaction system;
d) calculating a price associated with said selected product designated by said entered vendor/product code;
e) determining existence of appropriate funds held on behalf of said consumer to cover purchase of said selected product;
f) responsive to indication of sufficient consumer funds for said consumer, sending an authorization signal from said remote computer transaction system to indicate authorization to dispense said selected product;
g) providing a record of purchase to said consumer; and,
h) transferring funds from said remote computer transaction system to said at least one vendor providing said selected product.

14. The method of claim 13, wherein step (b) of communicating with a remote computer transaction system includes the substep of transferring funds from said consumer to a transaction account within said remote computer transaction system.

15. The method of claim 14, wherein step (b) of said consumer communicating with said remote computer transaction system includes the substeps of providing prompts to lead said consumer through a series of steps necessary to complete a transaction.

16. The method of claim 15, wherein said vendor/product code comprises a two-dimensional image.

17. The method of claim 16, wherein said consumer enters a vendor/product code corresponding to a selected product by scanning said two-dimensional image.

18. The method of claim 13, wherein a computer is used to enter information with said remote computer transaction system.

19. The method of claim 13, wherein a landline telephone connection is used to enter data into said remote computer transaction system.
